(19) United States
(12) Patent Application Publication
(10) Pub. No.: US 2008/0077609 A1
(43) Pub. Date: Mar. 27, 2008

(54) SYSTEM AND METHODS FOR CONTEXT BASED NAVIGATION

(75) Inventor: Benzi Ronen, Ramat Gan (IL)

Correspondence Address: SAP PORTALS ISRAEL LTD., 15 HATIDHAR STREET, RA'ANANA, 43665, omitted

(73) Assignee: SAP Portals Israel Ltd., Ra'anana (IL)

(21) Appl. No.: 11/534,120

(22) Filed: Sep. 21, 2006

(51) Int. Cl. G06F 7/00

(52) U.S. Cl. 707/102

(57) ABSTRACT

A system and method to allow a user in a portal environment to obtain content relevant to the user in resolving and investigating alerts and performing tasks is described. In one embodiment, when a user is notified by an alert associated with the user, a content navigation system dynamically asses the needs of the user, and provides the user with navigation links to content related to the alert and to the user. The content may include applications and data associated with the user's system, and/or other systems available to the user. In another embodiment, the system provides the user with one or more recommended navigational data paths that provide the user with the ability to quickly find relevant applications and data in resolving and investigating underlying causes of alerts and performing tasks.

The present application is related to co-pending patent application Ser. No. 10/879,484, entitled “Object Based Navigation”, filed Jun. 28, 2004, the entire contents of this application is herein incorporated by reference for all purposes.

### BACKGROUND

The present invention relates to the field of human-computer interaction, and in particular to user interfaces and systems in a portal environment for querying databases and presenting references to applications and data to users of the portal environment.

Computer networks have become ubiquitous in business, industry, and education allowing users to search for and process information for a variety of topics and business needs. Development and wide acceptance of the Internet have enabled network resources, accounts and applications to become available from almost anywhere in the world and at virtually anytime. The Internet is most commonly used in the World Wide Web (“The Web”) environment.

Businesses of any significant size now see the Internet and effective use of computers as being crucial to their business strategies by allowing them to obtain and process large amounts of data to help supply their customers' needs. Computer networks such as the Internet have enabled a plethora of networks to serve as a platform for global electronic commerce, as seen by the rise of Yahoo!, EBay and Amzaon.com. The Internet enables easy exchange of information between users. The Internet uses the hypertext protocols to present information, which greatly simplifies the information retrieval by users. Such ease of information access allows user's to obtain and process data from a variety of data sources.

Increasing demand for data by businesses from many data sources, systems, and processes has led to a great demand for business or enterprise applications that are used to better organize, store, and process data, and to provide their customers with data relevant to their needs. Increasingly, enterprise applications are being provided in a portal environment due to its ease of use and effectiveness in integrating together complex databases and systems having different formats. One enterprise portal is mySAP.com™ provided by SAP AG. Such portal environments enable a business user query data for their particular business operation from a variety of customer accessible databases. These databases may also be stored in many different geographic locations.

In some situations, users may want to combine data they have retrieved from more than one database to suit a particular need. In an open system, such as the Web, users may obtain information from different sources without modifying the underlying applications that generated the data. Illustratively, a third party independent software vendor (ISP) may provide an application and graphical user interface (UI) to a user that combines demographic data, such as average family income using one application, with a map from another application, to provide a map display of the average income for families within the mapped area. Generally such data combinations are referred to as “mash-ups”.

In closed system, such as a enterprise portal environment, where systems and applications are proprietary, and usually accessible to customers of the portal system, users often combine and modify two or more underlying applications to generate a new integrated application that is designed to provide information according to a user's needs. During the development of the new application, developers currently provide fixed “hard coded” navigation links to help users navigate between application windows, functions, and data that suit the user's needs. Such hard coded links are generally determined from, for example, company information, user requests, etc.

Unfortunately, the current approach of integrating applications often relies on the developers having to predetermine (e.g., guess) which hard coded links to use that point users to content which is relevant, and which links will be available upon deployment of the application. In addition, software developers must predict which content is relevant to different users, and predict in a business portal environment, which content will be useful to a particular user in responding to a system alert. For example, developers must predict what content is relevant to users responding to an alert associated with accounting, shipping, engineering, etc.

Generally this approach has been successful with enterprise portal systems with a manageable number of databases, content, alerts, systems, and users. However, as portal systems move toward providing users with meaningful content from data sources inside the portal network combined with content from thousand if not millions of data sources outside the enterprise portal system to solve the user business issues, such as the Internet, predicting and providing content relevant to user needs becomes exponentially more difficult.

Therefore, what is needed is a portal environment which includes a system that dynamically assesses the needs of a user, and provides navigable links to content relevant to the user with respect to the user's business needs.

### BRIEF SUMMARY

Embodiments of the present invention include a dynamic content navigation system capable of providing content relevant to a user needs according to a user's attributes such as the user's role in an organization, user profile, etc. and one or more alerts associated with the user. In one embodiment, in response to receiving an alert associated with the user, the content navigation system uses the user attributes to locate content relevant to the user and the alert. The content navigation system determines which business objects are relevant to the user and the alert, and uses user's attributes, alert attributes, and interrelationships between the business objects to provide a navigable data path to those relevant business objects. In an embodiment, the content navigation system ranks the navigable data paths to determine a recommend course of action to the user to resolve the alert and/or investigate underlying causes of the alert.

In one embodiment, the present invention provides a method in a portal environment of dynamically assessing and providing navigational links to applications and data relevant to a user. The method includes receiving a set of user attributes, receiving an alert associated with the user, performing a query in a portal environment using the set of user attributes and alert attributes associated with the alert to locate content relevant to the user, and based on the set of user attributes and the alert attributes, determining at least one navigable data path to content that allows the user to respond to at least a portion of the alert.

In one embodiment, the present invention provides a computer system configured to determine a navigable data path to applications and data relevant to a user of a portal system in investigating and resolving an alert. The computer system includes a processor, a computer readable storage medium coupled to the processor. The computer readable storage medium includes instructions stored therein for directing the processor to provide a user with at least one navigable data path to objects associated with applications and data relevant to the user, and associated with an alert associated with the user. The instructions include code for performing a database query to locate objects pointing to applications and data relevant to user attributes and alert attributes, and code for providing at least one navigable data path for the user to at least one combination of the objects that enables the user to complete at least a portion of the alert.

In one embodiment, the present invention provides a method of generating a navigable data path for users of a portal environment. The method includes detecting an event associated with a portal environment, obtaining user attributes for users of the portal environment associated with the event, obtaining event attributes, querying at least one database using the user attributes and event attributes to generate a set of objects pointing to applications and data associated with at least one user and event, and providing at least one data path from the results of the query to a set of objects that allow the user to at least partially respond to the event.

### BRIEF DESCRIPTION OF THE DRAWINGS

FIG. 1 is a simplified block diagram of one embodiment of a system for context based navigation in accordance with embodiments of the invention;

FIG. 2 is a high-level illustration of memory including a context based navigation engine for generating links to content relevant to a user in accordance with embodiments of the invention;

FIG. 3 is a high-level block diagram illustrating a context based navigation system including the context based navigation engine in accordance with embodiments of the invention;

FIG. 4 is a method of generating content relevant to user attributes in response to an alert associated with the user's attributes and alert attributes in accordance with embodiments of the invention;

FIG. 5 is a high-level illustration of a graphical user interface for displaying content relevant to a user in response to an alert in accordance with embodiments of the invention;

FIG. 6 is a high-level illustration of a graphical user interface displaying links and data paths relevant to a user in response to an alert in accordance with embodiments of the invention;

FIG. 7 is a high-level illustration of a graphical user interface displaying one process for a user response to an alert in accordance with embodiments of the invention;

FIG. 8 is a high-level illustration of a graphical user interface displaying navigable data paths to objects pointing to content, where one data path is a system recommended data path in accordance with embodiments of the invention;

FIG. 9 is a high-level illustration of a graphical user interface for selecting data relevant to an alert in accordance with embodiments of the invention;

FIG. 10 is a high-level illustration of a graphical user interface for navigating to relevant content along a data path in accordance with embodiments of the invention; and

FIG. 11 is a high-level illustration of a graphical user interface for selecting specific data relevant to an alert in accordance with embodiments of the invention.

These and other embodiments of the invention are described in further detail below.

### DETAILED DESCRIPTION OF EXEMPLAR EMBODIMENTS

Embodiments of the present invention include a content navigation system capable of assessing a user's needs with respect to alerts associated with an enterprise portal system. The content navigation system enables the user to investigate and/or resolve the alerts by providing the user with target content information relevant to the alerts, and a user's attributes. In one embodiment, in response to a user's attributes and a system alert, the context navigation system performs a query that locates objects pointing to target content relevant to the user's attributes and to the alert. In one embodiment, the content navigation system generates a user interface file (e.g., XML file) that may be used to provide a user with a user interface (UI) displaying at least one navigable data path to relevant content that may assist the user in responding to the alert. Users within a business organization having different attributes may be provided with different content relevant the alert and to each user's attributes. Accordingly, each user may be provided with different navigable data paths to resolve the alert with respect to their particular role in the organization.

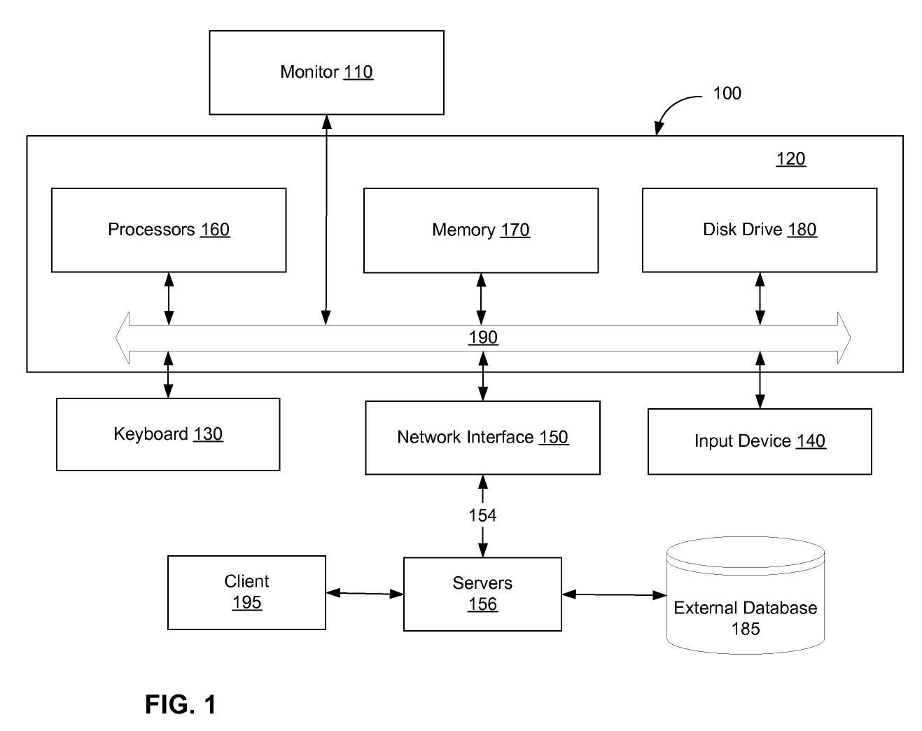

FIG. 1 is a block diagram of a context navigation system 100 according to an embodiment of the present invention, context navigation system 100 depicted in FIG. 1 is merely illustrative of an embodiment incorporating the present invention and is not intended to limit the scope of the invention as recited in the claims. One of ordinary skill in the art would recognize other variations, modifications, and alternatives.

In one embodiment, context navigation system 100 includes a display device 110 such as a monitor, computer 120, a keyboard 130, a user input device 140, a network communication interface 150, and the like. In one embodiment, user input device 140 is typically embodied as a computer mouse, a trackball, a track pad, wireless remote, and the like. User input device 140 typically allows a user to select objects, icons, text and the like that appear on the monitor 110.

Embodiments of network interface 150 typically include an Ethernet card, a modem (telephone, satellite, cable, ISDN), (asynchronous) digital subscriber line (DSL) unit, and the like. Network interface 150 is typically coupled to a communication network 152, such as the Internet, to one or more servers 156 and/or database 185 that may be located outside the context navigation system 100. In other embodiments, network interface 150 may be physically integrated on the motherboard of computer 120, may be a software program, such as soft DSL, or the like.

In one embodiment, source code for an application is deployed and stored on server 154. Server 154 is configured to serve the source code to context navigation system 100 over, for example, communication network 152 in response to a request for the application such as a webpage from server 154. In one embodiment, the client program that executes the application is a browser application.

In one embodiment, context navigation system 100 may also include software that enables communications over communication network 152 such as the HTTP, TCP/IP, RTP/RTSP, protocols, wireless application protocol (WAP), and the like. In alternative embodiments of the present invention, other communications software and transfer protocols may also be used, for example IPX, UDP or the like. In one embodiment, communication network 152 may include a local area network, a wide area network, a wireless network, an Intranet, the Internet, a private network, a public network, a switched network, or any other suitable communication network.

Communication network 152 may include many interconnected computer systems and communication links such as hardwire links, optical links, satellite or other wireless communications links, wave propagation links, or any other suitable mechanisms for communication of information.

Computer 120 typically includes familiar computer components such as a processor 160, and memory storage devices, such as a memory 170, e.g., random access memory (RAM), disk drives 180, and system bus 190 interconnecting the above components. In one embodiment, computer 120 is a PC compatible computer having multiple microprocessors. While a computer is shown, it will be readily apparent to one of ordinary skill in the art that many other hardware and software configurations are suitable for use with the present invention.

Memory 170, disk drives 180, and database 185, and are examples of tangible media for storage of data, audio/video files, computer programs, embodiments of the herein described invention including test panel engine, reporting engine, report display engine, and the like. Other types of tangible media include floppy disks, removable hard disks, optical storage media such as CD-ROMS and bar codes, semiconductor memories such as flash memories, read-only-memories (ROMS), battery-backed volatile memories, networked storage devices, and the like.

In one embodiment, as described below, memory 170 includes context navigation engine 172. In an embodiment, context navigation engine 172 may be a separate application or may be part of another software application. For example, context navigation engine 172 may be part of a search engine on a server machine, or may be part of a client side application communicating over a network, such as network 152.

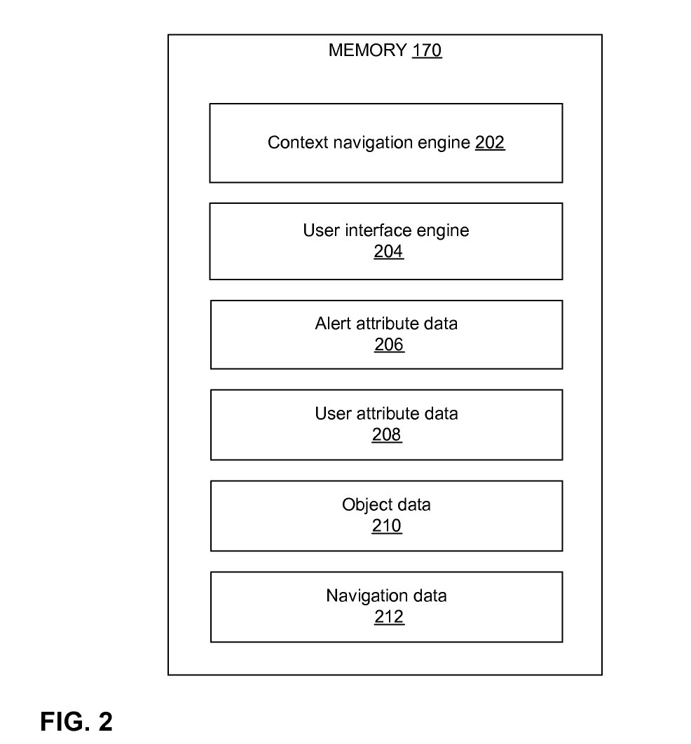

FIG. 2 is a high-level illustration of memory 170 which includes context based navigation engine 202, a user interface engine 204, alert attribute data 206, user attribute data 208, object data, and content navigation path data 210. As described further below, context navigation engine 172 is a software engine that facilitates a user in generating content relevant to the user's particular business problem, informational need, etc in response to an alert or task associated with the user.

User interface engine 204 may be any suitable data interface application, such as a web server capable of serving data to a browser or other graphical user interface (GUI) such as a portal user interface, portal snippets, FRAMEWORK page, and the like. Such user interface programs are generally resident on a client 195 capable of displaying content such as HTML to the user in the form of graphical interface such as a webpage. Portal snippets such as iVIEWS, are presentation components that may perform certain operations to retrieve and view data.

Alert attribute data 206 includes data having context relevant to one or more alerts. For example, alert data may contain system events, business process events, time events, date events, and the like. In one embodiment, alert attribute data 206 may include alerts pertaining to events specific to the user's systems, such as a customer's enterprise software system, or to alerts pertaining to events that may occur outside the user's system. For example, alert attribute data 206 may contain data pertaining to an internal factor such as an accounting error within the user's accounting process, or may contain data pertaining to an external factor, such as a hurricane disrupting a shipping line the user employs to ship products to customers. Such alerts may include for example, alerts pertaining to weather, manufacture flow, materials, incoming receiving, and the like. Alert attribute data 206 may be stored in any suitable form such as in the form of metadata, objects, and the like.

User attribute data 208 relates to data having context associated with the user such as the user's personal profile, business role, access level, content presentation, priority level, association with tasks, association with alerts, association with events, association with applications, history of alert resolution, and the like. For example, user attribute data 208 may contain data pertaining to a shipping manager who's role it is to make sure that products are shipped to customers, who has access to information related to shipping and receiving, weather forecasting, shipping lines, warehousing, manufacturing, etc., and who is interested in alerts pertaining to factors that may affect shipping such as weather alerts, manufacturing alerts, material alerts, etc.

In one embodiment, user attribute data 208 is stored in a session container that maintains the user's metadata from sessions to session. The session container may be configured with a common interface or handshake useable with the business objects located by context navigation engine 202, such that the user's metadata may be usable by internal and external applications.

Object data 208 may include business objects, or just “objects”, which are a module or set of instructions that are modeled to perform a certain task or behavior. Business objects may represent a concept, thing, process, content, event, task, etc., associated with an organizations operation, planning, accounting, sales, and the like. Each business model object specifies attributes, relationships, and actions/events. For example, business objects may be used to represent purchase orders, suppliers, system users, applications, etc.

Navigation data 208 may include links between objects that define one or more navigable data paths described further below. For example business objects may be linked such that users may dynamically pass content from one content source to another. Business objects may be linked such that a purchase order object may be linked to a sales order, to a customer, to a product, etc. Such business object navigation allows a user to efficiently locate contextually relevant content as described further below.

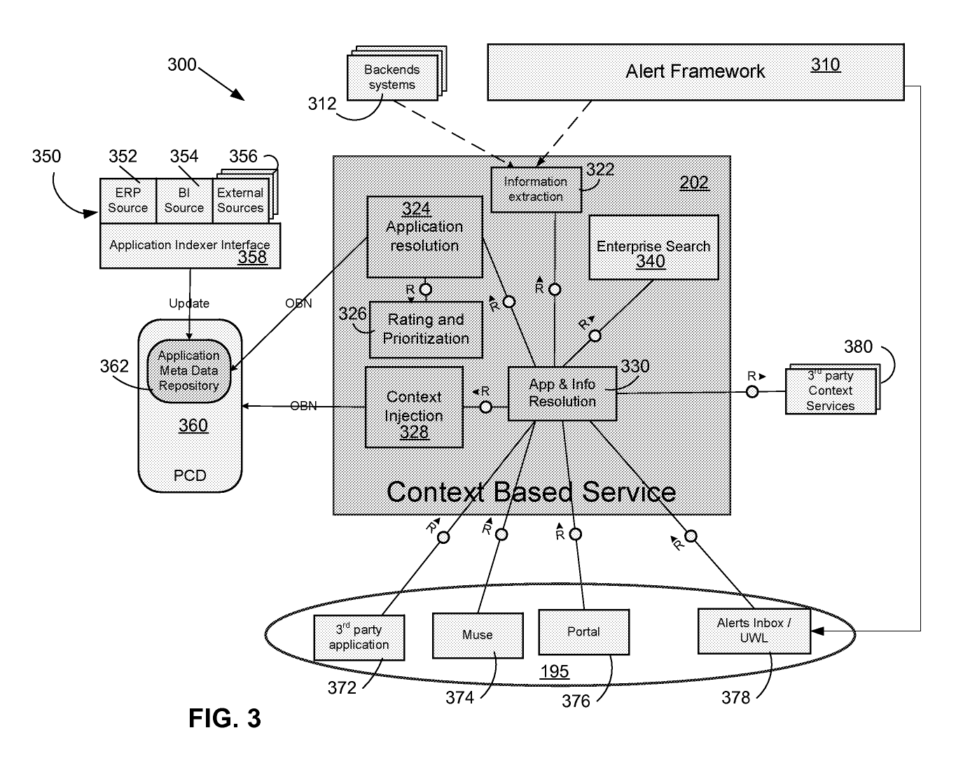

FIG. 3 is a high-level block diagram illustrating a context based navigation system 300. Context based navigation system 300 may include context navigation engine 202. In one embodiment, context navigation engine 202 provides a context based service to one or more clients 195, an alert framework 310, communication to backend systems 312, application interface 350, portal content directory (PCD) 360, and may communicate with third-party context services 380.

Context navigation engine 202 may also be configured to manage incoming requests from alerts and users, process the requests, and provide content relevant to client 195. For example, in response to a system alert, context navigation engine 202 provides client 195, one or more navigable data paths with content contextually relevant to a user and the alert though a third party applications 372.

In one embodiment, the navigable data paths may be displayed on third party applications 372 such as browser interface, a MUSE interface 374 which allows users applications from their Macintosh, Linux or Windows desktops and from mobile devices, a portal 376, and through a UNIVERSAL WORKLIST (UWL) 378 which provides users a unified and centralized way to access their work and the relevant information in portal 376.

In other embodiments, context navigation engine 202 may supply navigable data paths for use by third party applications such as GOOGLE MAPS, EBAY auction applications, other enterprise portal applications, etc. through client 195 to allow such third party applications to perform mash-ups. For example, navigable data paths with third party access may be used by other applications to form mash-ups with contextually relevant content from inside and outside the user's enterprise portal system. Illustratively, a third party may mash-up sales office locations associated with the portal system user with a mapping program outside the portal system, to generate a map of the sales locations for use by the third party.

In order to locate and generate contextually relevant content, context navigation engine 202 may employ enterprise search engine 340. Enterprise search engine 340 may be configured to query internal data sources and external data sources, such as external database 185. Query results may be used as part of relevant content presented to the user as described herein. Enterprise search engine 340 may also be used in parallel with context navigation engine 202 to provide the user with other data that may not be contextually relevant, but may be associated. For example, the user may use enterprise search engine 340 as a conventional search engine to run a query to locate types of accounting software similar to what is used in the portal system.

In one embodiment, context navigation engine 202 may include an application and content resolution engine 330. As described herein, application and content resolution engine 330 may be used to receive one or more alerts internal and external to the portal system, and provide contextually relevant content to users via client 195. Application and content resolution engine 330 is coupled to an information extraction engine 322, an application resolution engine 324, a context injection engine 328, third party context services 380, and client 195, as described further below.

Application and content resolution engine 330 may be configured as a core process used to process alert attributes, perform queries to determine which applications are information are relevant to a user associated with the alert, and provide navigable data paths to relevant content to a user via client 195. In an embodiment, application and content resolution engine 330 maps application metadata with user metadata (e.g., user attributes) and alert metadata (e.g., alert attributes) to determine which content is contextually relevant for a particular user and associated alerts.

Alert framework 310 may generate an alert based on rules governing a particular business process, system event, etc. and associates alert attributes 206 to the alert, and pass the alert attributes to information extraction engine 322. Alert framework may be system driven by detecting system interrupts, for example, or may generate an alert from another source such as a user initiated alert. For example, an accounting alert may be driven by an accounting application when a certain data threshold is reached (e.g., account is past due), or may be derived from a user in sales who wants to give manufacturing advance notice that a sale has been made before the purchase is entered. Alert framework 310 may also provide direct alerts to users, for example, via an email transmitted to client 195.

In one embodiment, information extraction engine 322 normalizes, enhances, and extends alert attributes 206 using for example, backend systems 312. For example, in response to alert framework 310 generating an accounting alert, information extraction engine 322 extracts attributes about the accounting alert, such as which purchase order is affected, and may extract related content from for example, a vendor database to determine which vendors are associated with the purchase order, or data from an external database 185.

In order to determine which applications to present to the client in relation to an alert, application and content resolution engine 330 may be configured to retrieve application data from application resolution engine 324. Application resolution engine 324 may process information pertaining to applications with the alert attributes 206, enhanced by information extraction engine 322, to determine, for example, which applications are best suited for solving a particular alert. In one embodiment, application resolution data engine 324 resolves the appropriate applications based on any number of suitable factors such as business objects, event context, role of a user, and may prioritize the alert according to ratings and prioritization data from a rating and prioritization engine 326.

In one embodiment as illustrated, application resolution engine 324 may be coupled to portal content directory (PCD) 360. Portal content directory (PCD) 360 may include a data repository 362 that stores for example, metadata related to applications accessible to context navigation system 100 through application interface 350. Application interface 350 is configured to obtain application data from a variety of applications either associated with the portal system, or not associated with the portal system such as applications from networks outside the portal system network. For example, application interface 350 may be in communication with and obtain attributes related to enterprise resource planning (ERP) applications 352, business intelligence (BI) applications 354, or other external applications 356.

In embodiments of the present invention, portal content directory 360 may also be updated by application and content resolution engine 330. Application and content resolution engine 330 may communicate with context injection engine 328 to enhance, extend, or clarify application data stored in for example, data repository 362. For example, consider the case where application data specifies all sales with the same application data. Context injection engine 328 in cooperation with application and content resolution engine 330 may extend the application to separate applications for example, used with automobile sales from those application used in camping equipment sales.

Context navigation engine 202 may use any number of suitable search schemas to communicate and query portal content directory 360. For example, context navigation engine 202 may query portal content directory 360 using business objects as the targets. Such business object query may be performed using “object based navigation” (OBN) incorporated herein.

In one embodiment, application and content resolution engine 330 may employ third party context services 380 to help determine which content is relevant to a user with regard to an event the user is responding to. For example, such third part context services 380 may provide metadata on third party applications that the user may not normally have access to. Such third party context services 380 may also provide other users outside the enterprise portal system access to content from the portal system to perform mash-ups of portal data with portal system data.

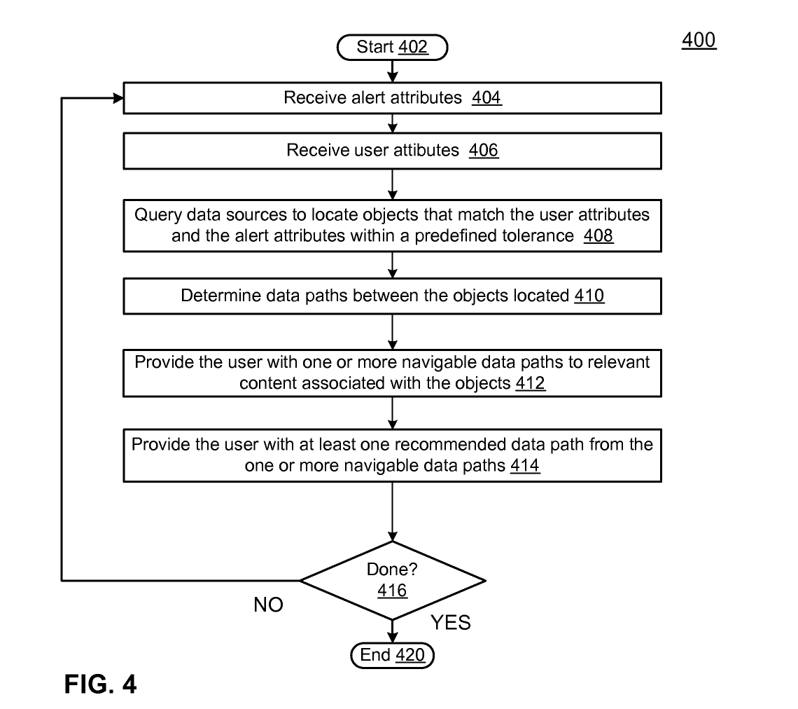

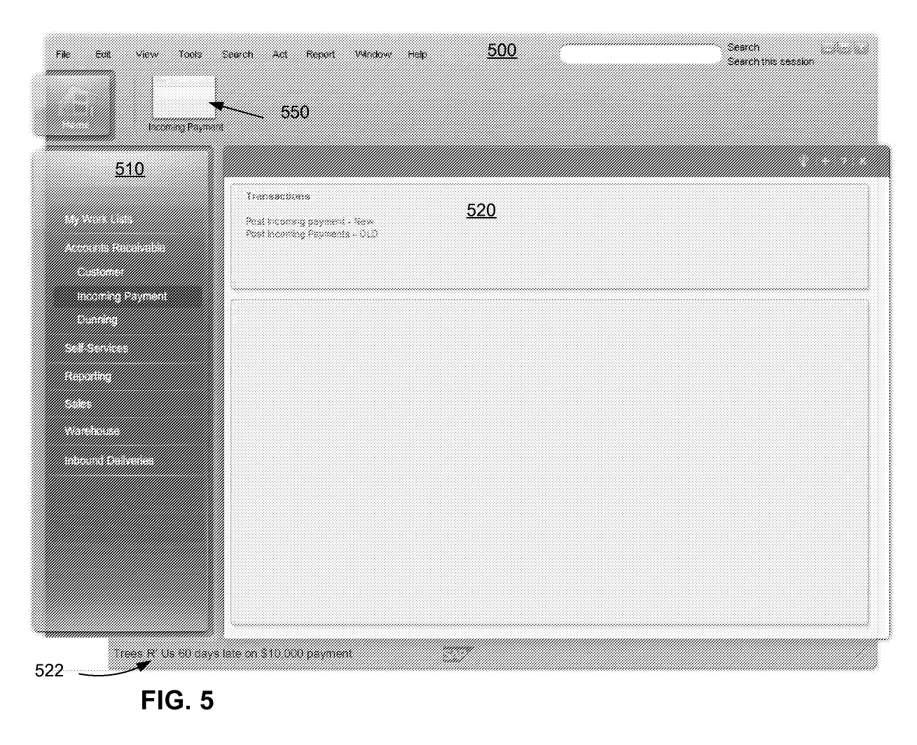

FIG. 4 is a method 400 of generating content relevant to user attributes in response to an alert associated with the user's attributes and alert attributes. Method 400 may be entered into at step 402 by a user's operating context navigation system 100 via a user interface 500 as illustrated in FIG. 5. Such a user interface 500 may include a navigation window 510 to enable a user to list operations the user is currently associated with, for example, accounts receivable, sales, etc. User interface 500 may also include data view window 520 used to supply the user for example, with data relevant to an alert and the user as described herein.

At step 404, alert attributes are received for example by alert framework 310. For example attributes pertaining to an alert 522 within user interface 500 are received. In this illustration the alert is used in alerting a user that a customer “Trees R' us is sixty days late on $10,000 payment”. Accordingly, alert attributes may include the customer's name “Trees R' us”, the type of transaction such as “payment”, date attributes such as “late”, amount of payment such as “$10,000”, and the like. Such alert attributes may be stored for example, in alert attribute data 206. At step 406, the user's attributes are retrieved from, for example, user-attribute data 208. In one embodiment, alert attributes may be refined and enhanced using information extraction engine 322. In order to act on the alert, the user may select the alert 522 using for example, a mouse, a pointer, and the like.

At step 408, a query is run to determine which applications and content are relevant to the user and the associated event. For example, referring to FIG. 3, context navigation engine 202 may utilize the alert attributes and the user attributes to query portal content directory 360, external databases 185, and the like. In one embodiment, context navigation engine 202 may employ enterprise search engine 340 to find such applications. Enterprise search engine 340 may be configured to query internal and external data sources using any number of suitable database and query schemas.

Referring to FIG. 4, at step 410, one or more navigable data paths are determined from the results of the query at step 408. In one embodiment, the interrelationships of the business objects are utilized to generate links between the objects. For example, context navigation engine 202 may utilize object based navigation to generate a list of objects and their links.

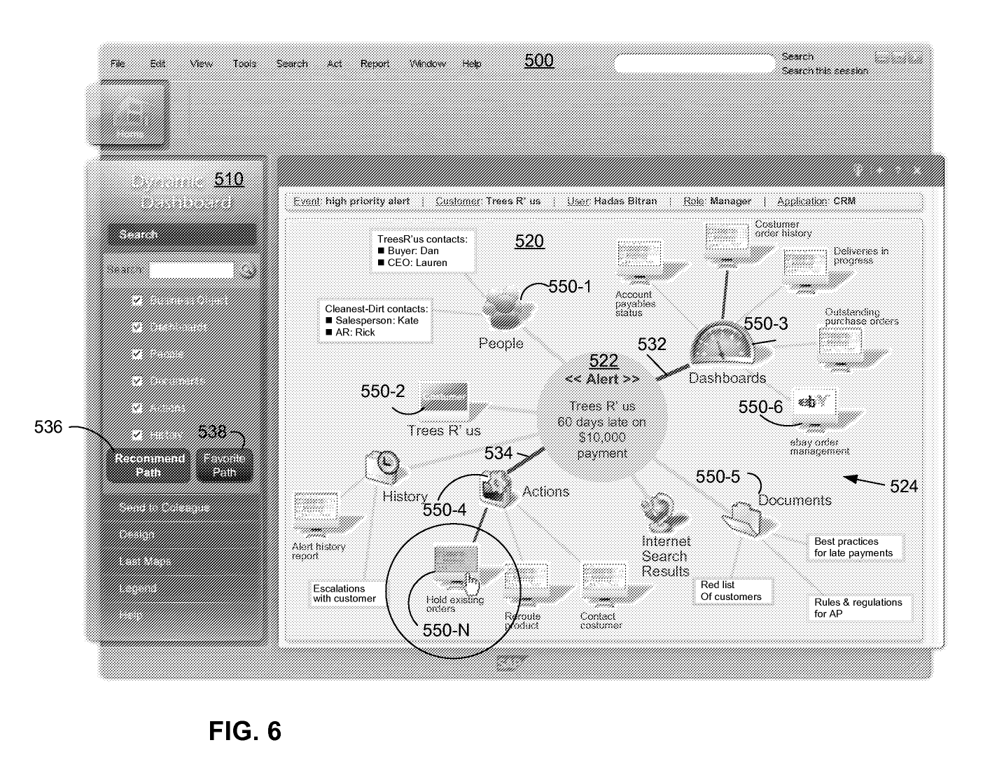

At step 412, a user is provided the relevant data and links. For example, after the user has selected alert 522 from FIG. 5, as illustrated in FIG. 6, a data window 520 is open that displays a plurality of navigable data paths 524. For example as illustrated navigable data paths 524 may be a graphical view of business objects linked together in a mind-map format extending from alert 522. While a mind-map structure is illustrated, those skilled in the art will appreciate that such data may be provided in a number of different ways. For example, as described above, such object data may be put into a XML format for use by a variety of applications.

As illustrated in FIG. 6, business objects may be displayed graphically in such a way as to provide additional information to a user, such as people 550-1, customers 550-2, dashboards 550-3, actions 550-4, documents 550-5, external sources 550-6, and processes 550-N, where “N” indicates a plurality of business objects.

In one embodiment, business objects may be analytics where upon selection by a user new windows such as a portal snippet, may be open showing results of analytical data analysis. For example, selecting dashboard 550-3 may open other windows that display the number of sales relevant to external sources 550-6, a map of the sales by region, sales with relations to billboard ads in a given region, etc.

A recommended data path 532 may be determined at step 414. For example, as illustrated in FIG. 6, recommended data path 532 connects alert 522 to business object 550-3, and alert 522 to actions 550-3. In one embodiment, recommended paths 532 and 534 may displayed by operating a recommended path button 536. In other embodiments, a user may define a path as a favorite path by selecting at least one business object coupled to the alert 522 and operating favorite path button 538. At step 416 of method 400 is finished it ends at step 420. If method 400 is not finished, the method 400 returns to step 404.

In one embodiment, context navigation engine 202 may collect data on past navigation behavior to allow context navigation engine 202 to provide data for future similar queries. For example, as each user navigates through the navigable data paths 524, context navigation engine 202 may track where each user is navigating such that context navigation engine 202 learns from each user. Paths that are commonly used for similar alerts may be ranked and stored for a future query. Therefore, context navigation engine 202 may use past navigation to learn from each user and provide a more precise query for similar alerts in the future.

A user's may also use their knowledge in other embodiments of the present invention to refine and modify rules and methods used in generating navigable data paths 524 and recommend paths such as recommended path 534. In this embodiment, as a user accesses business objects related to a particular data path, the user can modify the business objects and rules selecting the business objects to further clarify the business object and/or rank the business objects with respect to its importance in resolving an event. For example, referring to FIG. 6, some of the data paths may be only slightly relevant to the alert. The user in this case may edit the object to “de-list” or delete the object from the data paths. Or alternatively, an experienced user who knows about a relevant object that is not listed, may add the object to the data paths. Similarly, data from favorite paths 528 from users may be collected and utilized to enable context navigation engine 202 to refine the process of recommending data paths. This is advantageous, as such processes allow context navigation system 202 to learn from experienced users, and pass on valuable information to less experienced users.

### Investigating and Resolving Alerts using Navigable Data Paths

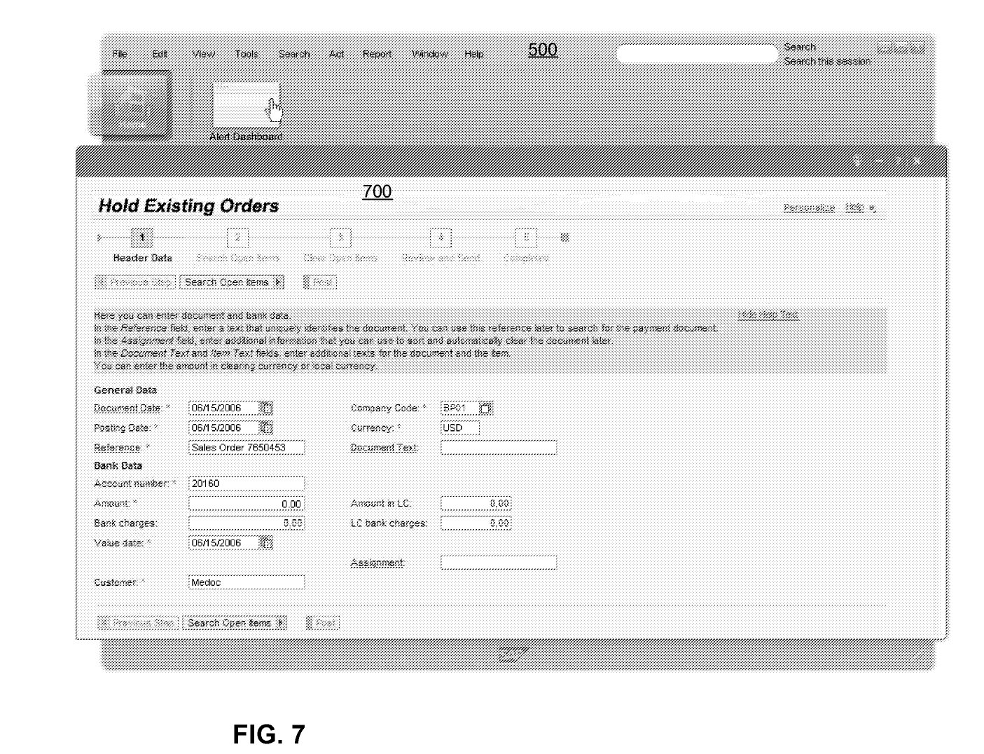

As illustrated in FIGS. 7-11, a user may use the navigable data paths 524 and related applications to resolve alerts. For example, in the current illustration of FIG. 5, an alert was provided to a user with regards to a late payment from a customer. In order to resolve the late payment alert, as illustrated in FIG. 6 and FIG. 7, a user may select any navigable data paths 524 associated with the alert to resolve and investigate causes of the alert. As described below, some data paths 524 lead to causes of the alerts, while other data paths 524 assist a user in resolving the alerts.

For example, if the user selects the recommend data path 532, a user may select business object 550-N pertaining to holding existing orders, which opens a new window 700. Such new window 700 allows the user to hold the orders of the customer which resolves the alert and issue of having future alerts based on the customer's payment history. In this case, using the recommended data path 532 has enabled the user to resolve the alert 522 without the need to investigate the underlying cause.

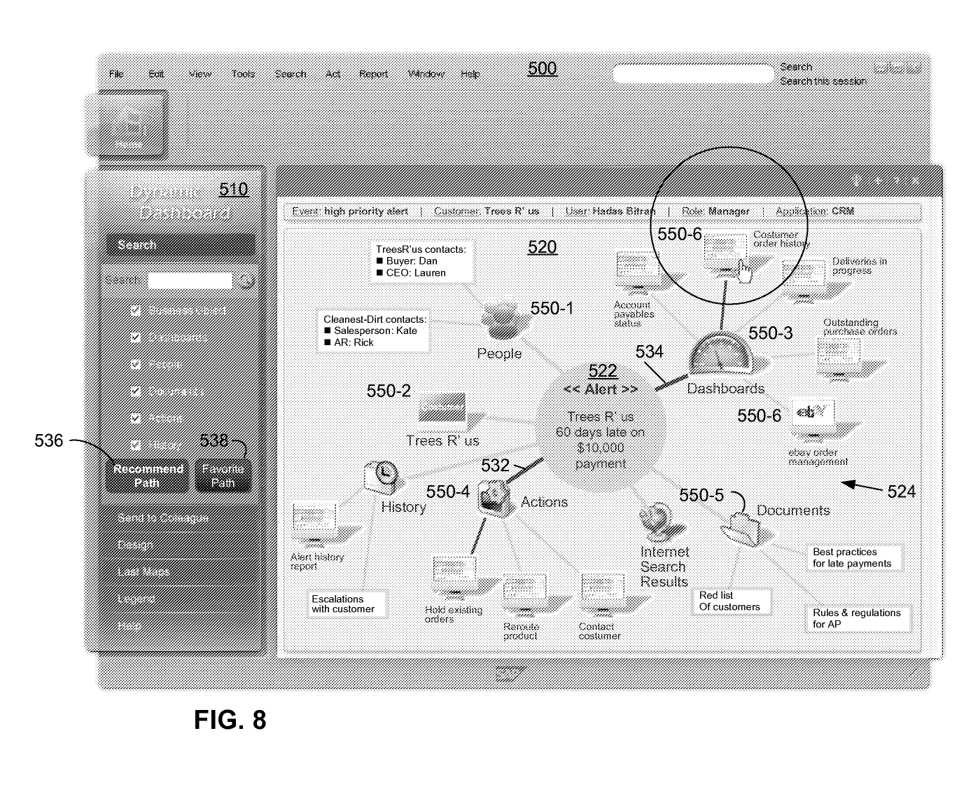

The user may also select the other recommended data path 534 to ascertain further information pertaining to the underlying cause of alert 522. For example, as illustrated in FIG. 8, the user may select business object 550-6 “customer order history”. In response to selecting business object 550-6, a new window 900 is generated that displays content relevant to the customers order history. As illustrated in data line 910, the customer in question “Trees R' Us” is associated with an employee “Tommy Barry”, where the status of a credit check is “pending”.

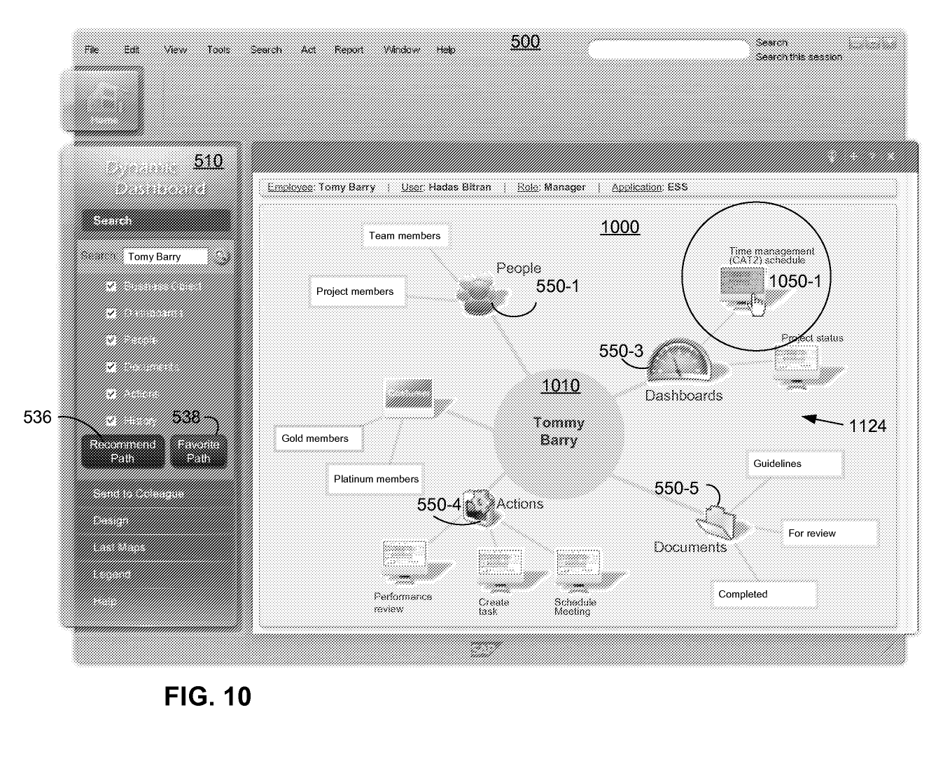

In one embodiment, the user is presented with a navigable link 920 in data line 910 to open another data view window 1000 illustrated in FIG. 10. Data view window 1000 displays a plurality of data paths 1124 that are linked to the employee business object “Tommy Barry” 1010. In this illustration, another mind-map is used to display navigable data paths 1124 associated with employee business object 1010. Similarly to navigable data paths 524, the user may use the navigable data paths 1124 with linked business objects to further investigate employee business object 1010.

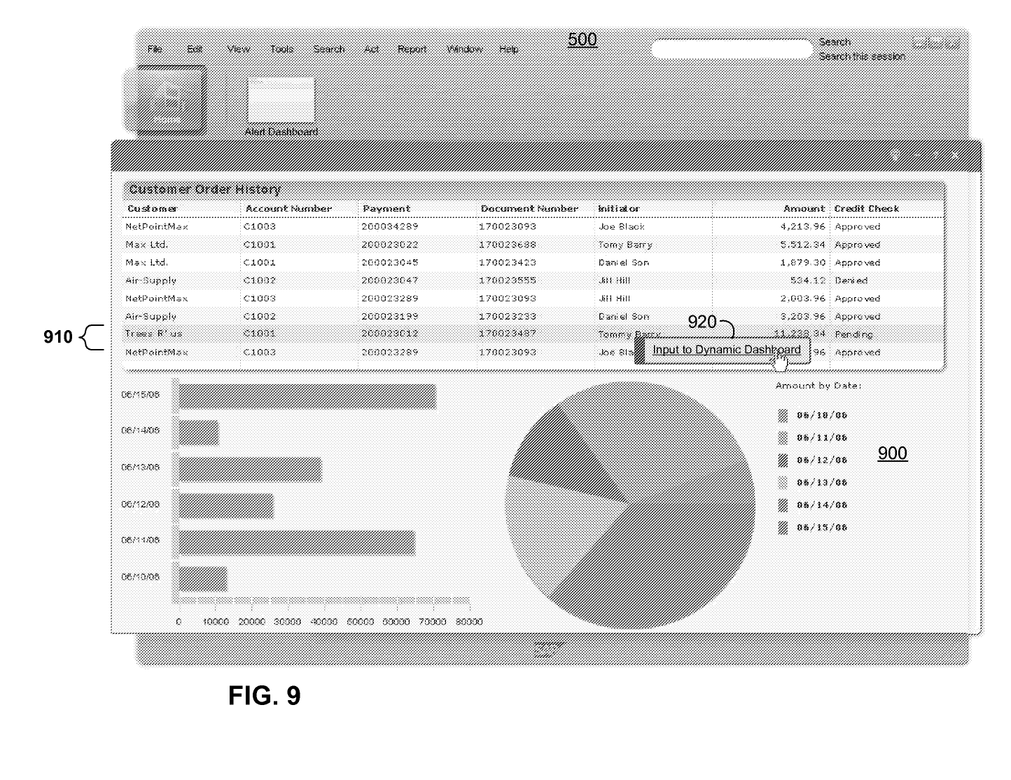

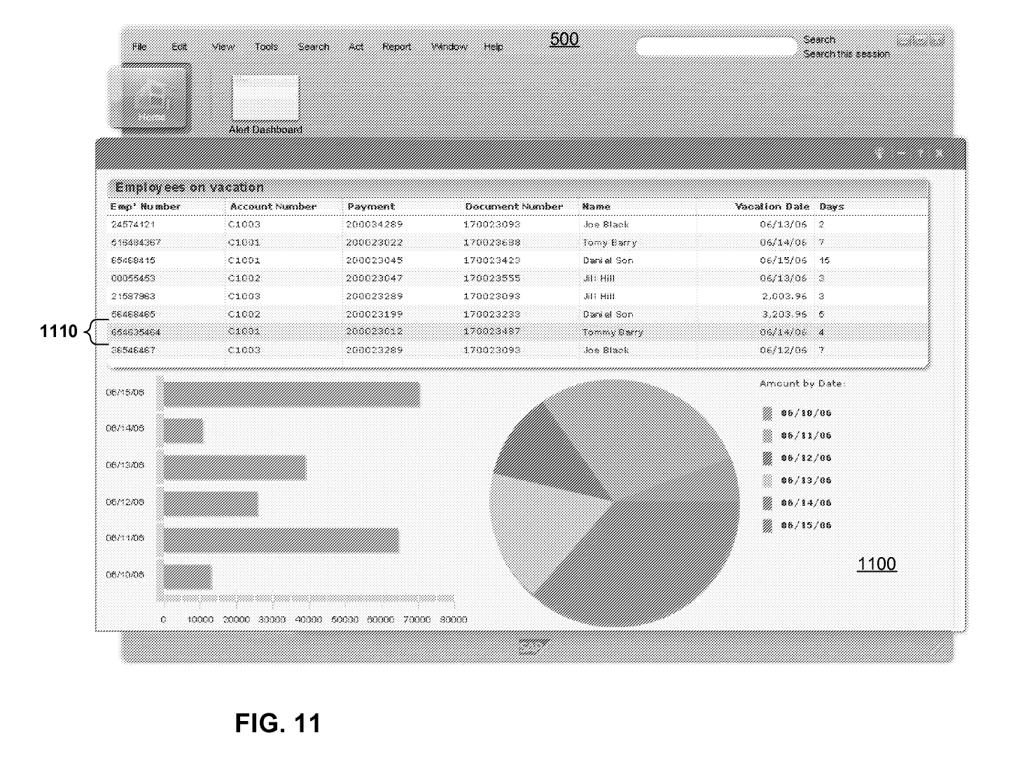

As illustrated in FIG. 10, to further investigate the underlying causes of alert 522, a user may selects a business object 1050-1 “time management schedule” to open a new window 1100 illustrated in FIG. 11. In this illustration, data line 1100 displays employee business object 1010 “Tommy Barry” on vacation. From this data, the user may deduce that the late payment alert 522 was caused by Tommy Barry being on vacation as, from FIG. 9, he had not completed a credit check.

Any of the above described steps may be embodied as computer code on a computer readable medium. The computer readable medium may reside on one or more computational apparatuses and may use any suitable data storage technology.

The present invention can be implemented in the form of control logic in software or hardware or a combination of both. The control logic may be stored in an information storage medium as a plurality of instructions adapted to direct an information processing device to perform a set of steps disclosed in embodiment of the present invention. Based on the disclosure and teachings provided herein, a person of ordinary skill in the art will appreciate other ways and/or methods to implement the present invention.

The above description is illustrative but not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method in a portal environment of dynamically assessing and providing navigational links to applications and data relevant to a user in resolving alerts, the method comprising:
receiving a set of user attributes;
receiving an alert associated with the user;
performing a query in a portal environment using the set of user attributes and alert attributes associated with the alert to locate content relevant to the user; and
based on the set of user attributes and the alert attributes, determining at least one navigable data path to content that allows the user to respond to at least a portion of the alert.

2. The method of claim 1, wherein the user attributes comprise metadata about the user.

3. The method of claim 1, wherein the alert attributes comprise metadata about the alert.

4. The method of claim 1, wherein the alert comprises one or more alerts associated with the portal system.

5. The method of claim 1, wherein the content comprises at least one business objects stored within a portal system database.

6. The method of claim 1, wherein the content comprises at least one business objects stored external to the portal system.

7. The method of claim 1, wherein performing the query comprises comparing metadata of the user and metadata of the alert with metadata of the content to determine within a predefined tolerance what content is relevant to the user.

8. The method of claim 1, wherein determining the at least one navigable data path comprises ranking a plurality of data paths.

9. A computer system configured to determine a navigable data path to applications and data relevant to a user of a portal system in investigating and resolving an alert, the computer system comprising:
a processor;
a computer readable storage medium coupled to the processor, wherein the computer readable storage medium includes instructions stored therein for directing the processor to provide a user with at least one navigable data path to objects associated with applications and data relevant to the user, and associated with an alert associated with the user, the instructions comprising:
code for performing a database query to locate objects pointing to applications and data relevant to user attributes and alert attributes; and
code for providing at least one navigable data path for the user to at least one combination of the objects that enables the user to complete at least a portion of the alert.

10. The computer system of claim 9, wherein code for performing the database query comprises code for comparing alert metadata and user metadata to application metadata to determine a relevance between the alert metadata, user metadata, and application metadata.

11. The computer system of claim 9, further comprising code for storing a user's metadata in a session container.

12. The computer system of claim 9, further comprising code for ranking the objects according to the objects relevance to the user attributes and alert attributes.

13. The computer system of claim 9, wherein code for extracting application metadata from applications independent of the portal system.

14. The computer system of claim 9, wherein code for providing the at least one navigable data path comprises code for ranking a plurality of navigable data paths to determine a recommended data path to a user.

15. A method of generating a navigable data path for users of a portal environment, the method comprising:
detecting an event associated with a portal environment;
obtaining user attributes for users of the portal environment associated with the event;
obtaining event attributes;
querying at least one database using the user attributes and event attributes to generate a set of objects pointing to applications and data associated with at least one user and event; and
providing at least one data path from the results of the query to a set of objects that allow the user to at least partially respond to the event.

16. The method of claim 15, wherein the user attributes comprise metadata about the user.

17. The method of claim 16, wherein the metadata comprises metadata pertaining to a user's organizational role, or a user's status, or a user's portal access.

18. The method of claim 15, wherein the event attributes comprise metadata pertaining to the portal environment, or metadata pertaining to events external to the portal environment.

19. The method of claim 15, wherein querying the at least one database comprises querying databases associated with the portal environment and querying databases external to the portal environment.

20. The method of claim 15, wherein providing the at least one data path comprises ranking a plurality of user navigable data paths to determine at least one recommended data path.
